(19) United States
(12) Patent Application Publication
(10) Pub. No.: US 2011/0055263 A1
(43) Pub. Date: Mar. 3, 2011

(54) Display system that integrates word explanations in different dictionary databases and method thereof

(75) Inventors: Chaucer Chiu, Taipei (TW); Xiao Yan Xu, Shanghai (CN)

(73) Assignee: INVENTEC CORPORATION, Taipei (TW)

(21) Appl. No.: 12/591,621

(22) Filed: Nov. 25, 2009

(30) Foreign Application Priority Data
Sep. 1, 2009 (TW) 098129388

(51) Int. Cl. G06F 17/30

(52) U.S. Cl. 707/770; 707/E17.032; 707/803

(57) ABSTRACT

This specification discloses a display system that integrates word explanations in different dictionary databases and the method thereof. When looking up a word, the system finds its explanations in different dictionary databases. After comparing the contents of the explanations with a same attribute, the system combines the repeated contents and keeps distinct ones. Finally, the system displays the combined and preserved explanations. It achieves the effects of integrate same or similar explanations and displays them, increasing the convenience for the user to read.

### BACKGROUND OF THE INVENTION

1. Field of the Invention

The invention relates to system and method of displaying word explanations and, in particular, to system and method of displaying that integrate word explanations in different dictionary databases.

2. Related Art

There are close and frequent economical and cultural exchanges between countries nowadays. People want to learn advanced technologies of other countries to facilitate the development of their own. With the advances in information technology and Internet, people can easily obtain information from abroad in this information global village. News from all over the world goes to our life via television, newspapers, magazines and the Internet. The chance for each person to encounter a foreign language thus is much greater than before. Because of this, it is inevitable for a person to learn a second or even third foreign language.

Currently, translation software has so many powerful functions that it has gradually replaced traditional paper dictionaries. The translation software can be widely used in various electronic devices, such as personal computers (PC's), personal digital assistants (PDA's), and mobile communication devices. The translation software has been developed to have multiple dictionaries, such as English-Chinese and Chinese-English dictionaries, Japanese-Chinese and Chinese-Japanese dictionaries, and professional dictionaries (for laws, computers, and other special fields). When a user wants to use the translation software to look up a word, he can simply move the mouse cursor over the word. The translation software looks up in all of the dictionaries whether there is at least a word explanation to match. It then displays all the word explanations in a translation window. Since the word explanations in several dictionaries are displayed simultaneously, it is possible that the display page is too long. This is inconvenient for the user to read.

In summary, the prior art always has the problem of possibly too long display pages for some word explanations. This is annoying for the user to read. It is therefore imperative to provide a solution.

### SUMMARY OF THE INVENTION

In view of the foregoing, the invention discloses a display system that integrates word explanations in different dictionaries and the method thereof.

The disclosed display system that integrates word explanations in different dictionaries includes at least: several dictionary databases, a receiving module, a searching module, an extracting module, a comparing module, and a displaying module. The dictionary databases store a plurality of word data, each of which corresponds to at least one explanation. Each of the explanations contains its attribute and dictionary number. The receiving module receives a word to be searched. The searching module searches for matched word data in the dictionary databases. The extracting module extracts the matched word data from the dictionary databases, obtaining the explanations, their attributes and corresponding dictionary numbers. The comparing module compares the contents of the explanations according to the same attribute. The explanations with repeated contents are combined and the corresponding dictionary numbers are recorded. The different explanations are preserved to obtain an updated list. The displaying module displays the explanations in the updated list and the attributes thereof.

The disclosed display method that integrates word explanations in different dictionaries includes the following steps at least. First, it establishes several dictionary databases, each of which stores a plurality of word data. Each of the word data corresponds to at least one explanation. Each of the explanations has its attribute and a dictionary number. The next step receives a word to be searched. The next step searches for matched word data in the dictionary databases. Explanations are extracted from the matched word data in the dictionary databases, along with their attributes and dictionary numbers. Explanations of the same attributes are compared in the contents. Explanations with repeated contents are combined and the corresponding dictionary numbers are recorded. Different explanations are preserved to obtain an updated list. Finally, the explanations in the updated list and their attributes are displayed.

The disclosed system and method differ from the prior art in that the invention searches a word in different dictionary databases. After comparing the contents of explanations with the same attributes of explanations, the invention combines repeated explanations and preserves different ones. Finally, the combined and preserved explanations are displayed. Thus, the invention achieves the goal of integrating same or similar explanations for the convenience of the user.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed display system that integrates word explanations in different dictionary databases;

FIG. 2 is a flowchart of the disclosed display method that integrates word explanations in different dictionary databases; and

FIGS. 3 to 8 are schematic view of the display system that integrates word explanations in different dictionary databases according to an embodiment of the invention.

### DETAILED DESCRIPTION OF THE INVENTION

Those Chinese characters shown in the following descriptions or in the drawings are just mentioned for describing the embodiments and are substantially irrelevant to any technical matters.

The present invention will be apparent from the following detailed description, which proceeds with reference to the accompanying drawings, wherein the same references relate to the same elements.

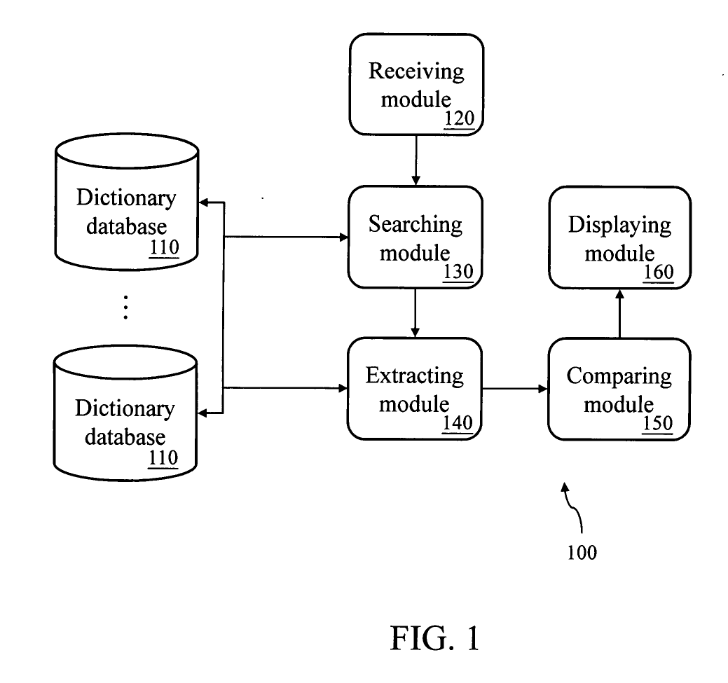

Please refer to FIG. 1, which is a block diagram of the disclosed display system that integrates different dictionary databases. The system 100 includes: several dictionary databases 110, a receiving module 120, a searching module 130, an extracting module 140, a comparing module 150, and a displaying module 160. The display system 100 that integrates different dictionary databases disclosed herein is applicable to translation software with multiple dictionary databases.

The dictionary databases 110 store a plurality of word data, each of which has at least one explanation. Each of the explanations has a corresponding attribute and dictionary number. Examples of the dictionary databases 110 include, but are not limited to, “English-Chinese dictionary”, “management dictionary”, or “financial and trade dictionary”. Each of the dictionary databases 110 stores much word data, such as “price”, “money”, and “rider”. Each of the word data corresponds to at least one explanation. Each of the explanations has an attribute and a dictionary number. The attributes include “n” representing nouns, “vt” representing verbs, and “adv” representing adverbs. The dictionary number is, for example, “0x00000301” to represent a number of the “English-Chinese dictionary”.

For example, the word datum “price” has the Chinese explanations [symbol] , [symbol] [symbol] , [symbol] , or [symbol] . The explanations [symbol] [symbol] [symbol] all have the attribute of “n” and the dictionary number “0x00000301”. On the other hand the explanation [symbol] [symbol] has the attribute “vt” and the dictionary number “0x00000301”.

The receiving module 120 receives a word to be searched, i.e., the word that a user wants to look up. It should be noted that the searched word can be the word where the mouse cursor is. That is, the user uses the mouse cursor to locate the word to be searched. The receiving module 120 then receives the word. For example, the user wants to look up the word “price”. Then the receiving module 120 receives the word “price”.

The searching module 130 searches for word data that match with the word in the dictionary databases 110. That is, the searching module 130 searches in all the dictionary databases 110 whether there is any match with the word received by the receiving module 120. In the above example, suppose the dictionary databases 110 include “English-Chinese dictionary”, “management dictionary”, and “financial and trade dictionary”. The searching module 130 looks up in the dictionary databases 110: “English-Chinese dictionary”, “management dictionary”, and “financial and trade dictionary” for the word “price. In the dictionary databases 110 of “English-Chinese dictionary” and “financial and trade dictionary”, the searching module 130 finds the matched word data for the word “price”.

The extracting module 140 extracts the explanations and the corresponding attributes and dictionary numbers of the matched word in the dictionary databases 110. That is, after the searching module 130 finds matched word data in the dictionary databases 110, the extracting module 140 extracts the explanations of the word data from the dictionary databases, along with the corresponding attributes and dictionary numbers.

In the above-mentioned example, after the searching module 130 finds the word data matching with the word “price” in the dictionary databases 110 of “English-Chinese dictionary” and “financial and trade dictionary”, the extracting module 140 extracts the explanations of “price” from the dictionary database 110 “English-Chinese dictionary”: [symbol] [symbol] or [symbol] [symbol] The explanations [symbol] [symbol] and [symbol] [symbol] have the attribute “n” and the dictionary number “0x00000301”. The explanation [symbol] has the attribute “vt” and the dictionary number “0x00000301”. The extracting module 140 also extracts the corresponding explanation [symbol] for “price” from the dictionary database 110 of “financial and trade dictionary”, along with the attribute “n” and the dictionary number “0x23000301”.

The comparing module 150 compares the contents of explanations with the same attribute in different dictionary databases 110. The explanations of repeated contents are combined, and the corresponding dictionary numbers are recorded. Explanations with different contents are preserved. An updated list is thus obtained. That is, the comparing module 150 uses the explanations and their attributes extracted by the extracting module to combine repeated contents of explanations with the same attribute and record the dictionary numbers thereof. Explanations of different contents are preserved. The combined explanations and the preserved explanations along with their attributes and dictionary numbers are recorded in the updated list.

In the above-mentioned example, the comparing module 150 compares the contents of the explanations [symbol] [symbol] and [symbol] [symbol] as they have the same attribute “n”. The explanation [symbol] has the attribute “vt” and is thus not compared with those of attribute “n”. The repeated content is found to be [symbol] and is combined. Also, the explanation [symbol] is recorded to have dictionary numbers “0x00000301” and “0x23000301”, which are then written into the updated list. The unrepeated explanations [symbol] [symbol] of attribute “n” and [symbol] [symbol] of attribute “vt” are preserved. The updated list thus includes the explanation [symbol] along with its attribute “n” and dictionary numbers “0x00000301, 0x23000301”, the explanations [symbol] [symbol] along with the respective attributes “n” and dictionary numbers “0x00000301”, and the explanation [symbol] [symbol] along with its attribute “vt” and dictionary number “0x23000301”.

The displaying module 160 displays the explanations and their attributes in the updated list. In other words, the displaying module 160 displays the explanations and their attributes in the updated list obtained by the comparing module 150. In the above example, the displaying module 160 displays the explanations [symbol] [symbol] [symbol] along with their attribute “n” and the explanation [symbol] [symbol] along with its attribute “vt” in the updated list.

It should be noted that the displaying module 160 can also display hyperlinks of the matched word data in the dictionary databases 110 according to the respective dictionary numbers. That is, in addition to the explanations and the attributes, the displaying module 160 further displays the hyperlinks of the matched word data in the dictionary databases 110 according to the different dictionary numbers of the explanations.

Through the operation of the display system that integrates word explanations of different dictionary databases, word explanations are searched for in different dictionary databases. Contents of explanations with the same attribute are compared. Explanations of repeated contents are combined. Unrepeated contents are preserved. Finally, combined and preserved explanations are displayed. This solves the problem in the prior art that the display page may be too long for the user to read when the word explanations in multiple dictionaries are displayed simultaneously.

In the following paragraphs, the disclosed method is explained with reference to an explicit embodiment. It should be emphasized that this example should not be used to restrict the scope of the invention. Any person skilled in the art can readily modify the embodiment with departing from the spirit of the invention.

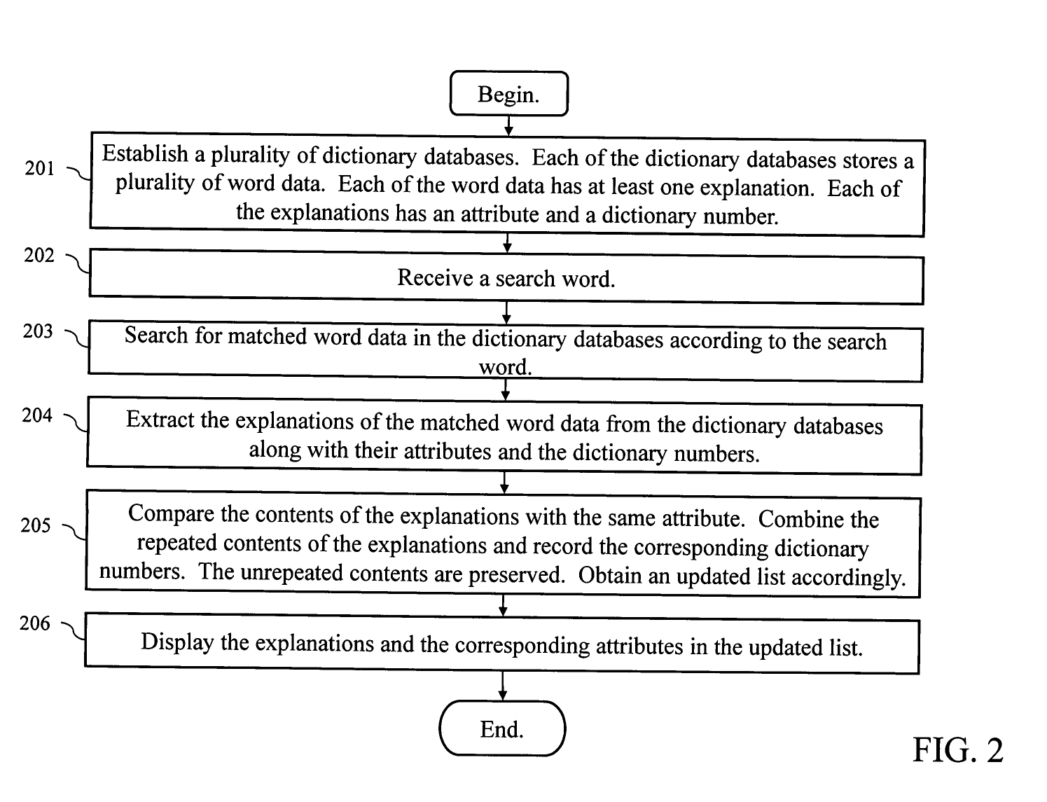

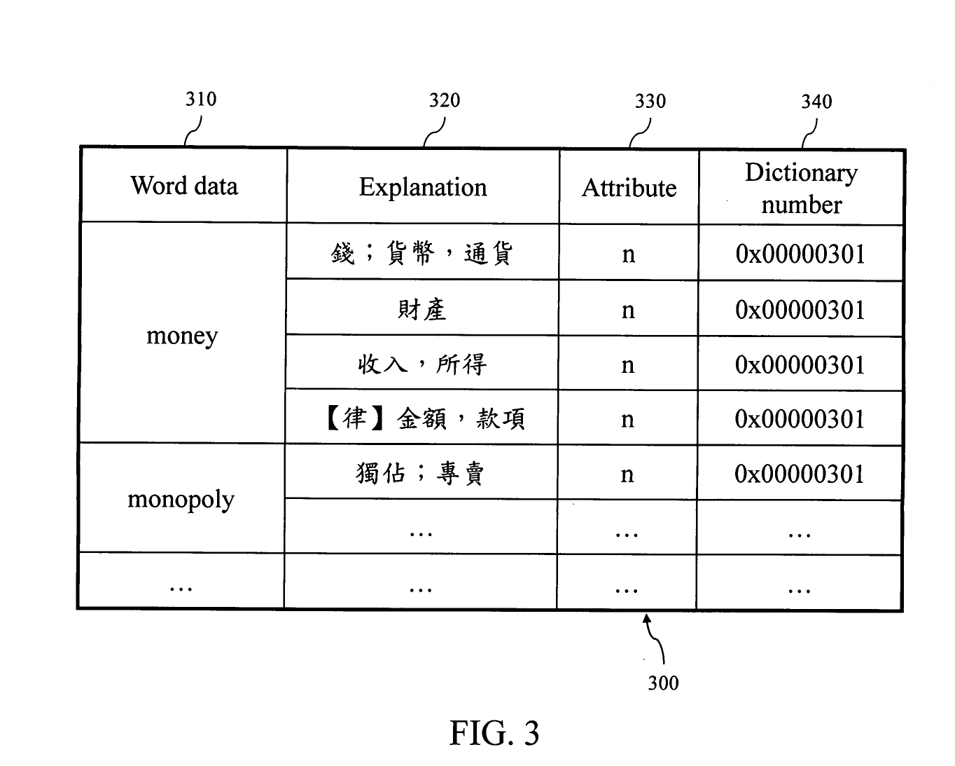

FIG. 2 is a flowchart of the disclosed display method that integrates word explanations in different dictionary databases. FIGS. 3 to 8 are schematic views of the disclosed display system that integrates word explanations in different dictionary databases. The following description uses FIGS. 2 to 8 explain the operating procedure of the disclosed display system that integrates word explanations in different dictionary databases.

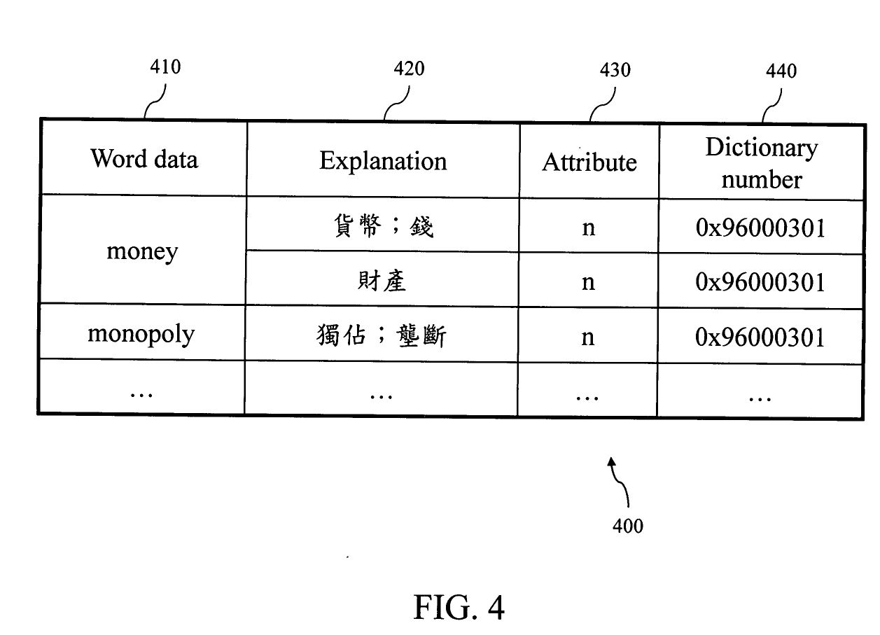

Please refer to FIGS. 3 and 4. The display system 100 that integrates word explanations in different dictionary databases first establishes an English-Chinese dictionary database 300 and management dictionary database 400. The English-Chinese dictionary database 300 includes word data 310 of explanations 320. Each of the explanations 320 has an attribute 330 and a dictionary number 340. Examples of the word data 310 are “money” and “monopoly”. Take the word datum 310 “money” as an example. The corresponding explanation 320 is [symbol] [symbol] [symbol] and [symbol] The explanation 320 [symbol] [symbol] [symbol] and [symbol] have respectively the attribute 330 “n” and the dictionary number 340 “0x00000301”. The management dictionary database 400 includes the word datum 410 of explanations 420. Each of the explanations 420 has an attribute 430 and a dictionary number 440. Examples of the word data 410 are “money” and “monopoly”. Take the word datum 410 “money” as an example. The corresponding explanation 420 [symbol] and [symbol] have the attribute 430 “n” and the dictionary number 440 “0x96000301”. (Step 201)

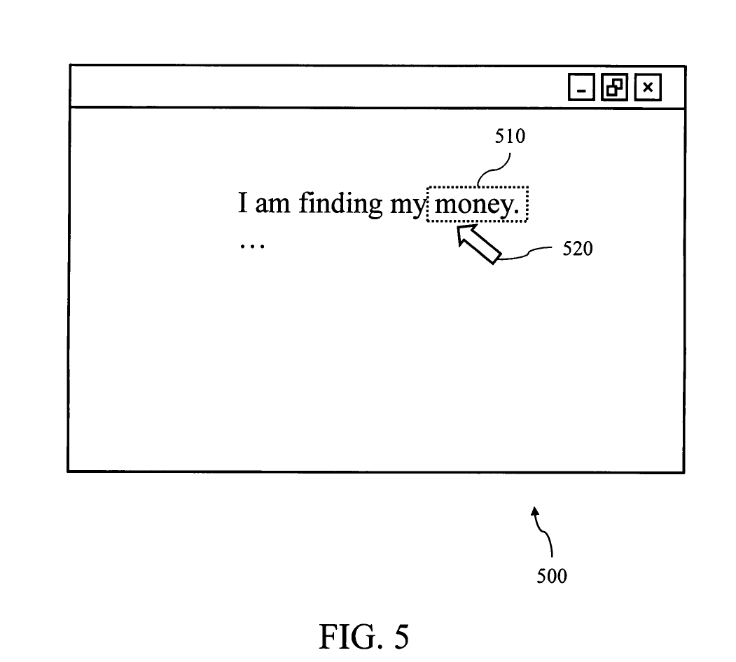

Please refer to FIG. 5. The word search operating interface 500 includes a search word 510 and a mouse cursor 520. When the user points the mouse cursor 520 to the search word 510 “money”, the system 100 extracts the search word 510 “money”. Afterwards, the disclosed system 100 receives the search word 510 “money” (step 202). Afterwards, the disclosed system 100 that integrates word explanations in different dictionary databases searches in the English-Chinese dictionary database 300 and the management dictionary database 400 for matched the word data. It finds the word datum 310 “money” in the English-Chinese dictionary database 300 and the word datum 410 “money” in the management dictionary database 400 (step 203).

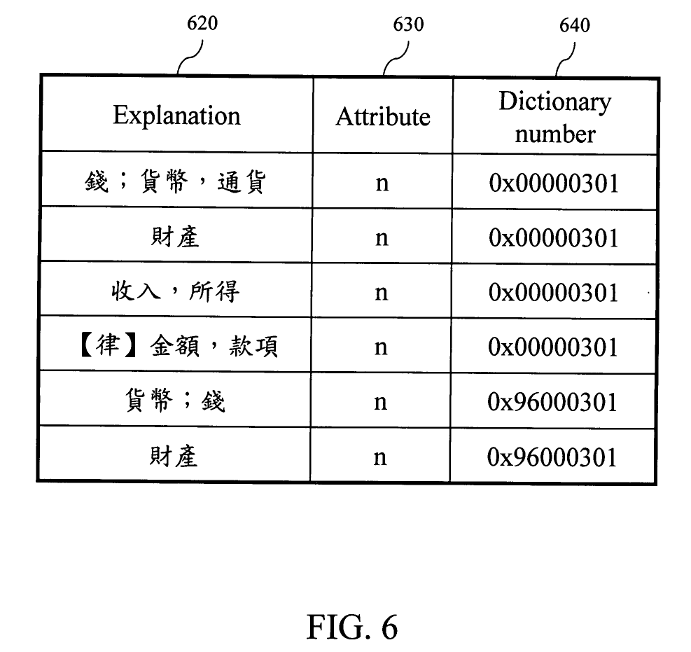

Please refer to FIG. 6. The disclosed system 100 that integrates word explanations in different dictionary databases extracts from the English-Chinese dictionary database 300 the explanation 320 corresponding to “money” as [symbol] [symbol] [symbol] [symbol] and [symbol] They all have the attribute 330 “n” and the dictionary number 340 “0x00000301”. Therefore, they are taken as the explanation 620 [symbol] [symbol] [symbol] and [symbol] [symbol] with the attribute 630 “n” and the dictionary number 640 “0x00000301”. The disclosed system 100 that integrates word explanations in different dictionary databases extracts from the management dictionary database 400 the explanation 420 corresponding to “money” as [symbol] and [symbol] They all have the attribute 430 “n” and the dictionary number 440 “0x96000301” (step 204). Therefore, they are taken as the explanation 620 [symbol] and [symbol] with the attribute 430 “n” and the dictionary number 440 “0x96000301”.

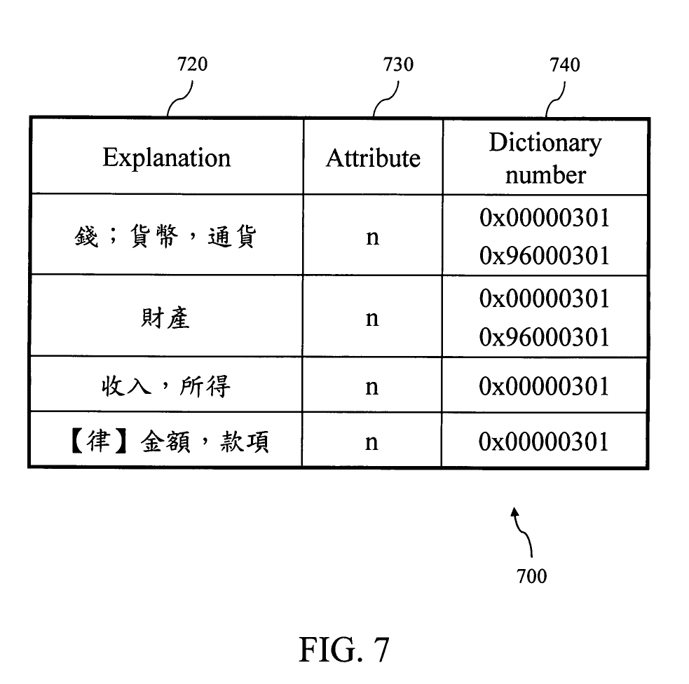

Please refer to FIG. 7. The disclosed system 100 that integrates word explanations in different dictionary databases compares the contents of the explanations 620 [symbol] [symbol] [symbol] [symbol] [symbol] [symbol] and [symbol] that all have the attribute 630 “n”. The repeated contents of the explanations 620 [symbol] and [symbol] are combined into the explanation 720 [symbol] in the updated list 700. Moreover, the dictionary numbers 640 “0x00000301” and “0x96000301” are combined to be the dictionary number 740 “0x00000301, 0x96000301” in the updated list 700. The unrepeated contents of the explanations 620 [symbol] and [symbol] are kept as the explanations 720 [symbol] and [symbol] in the updated list 700 (step 205).

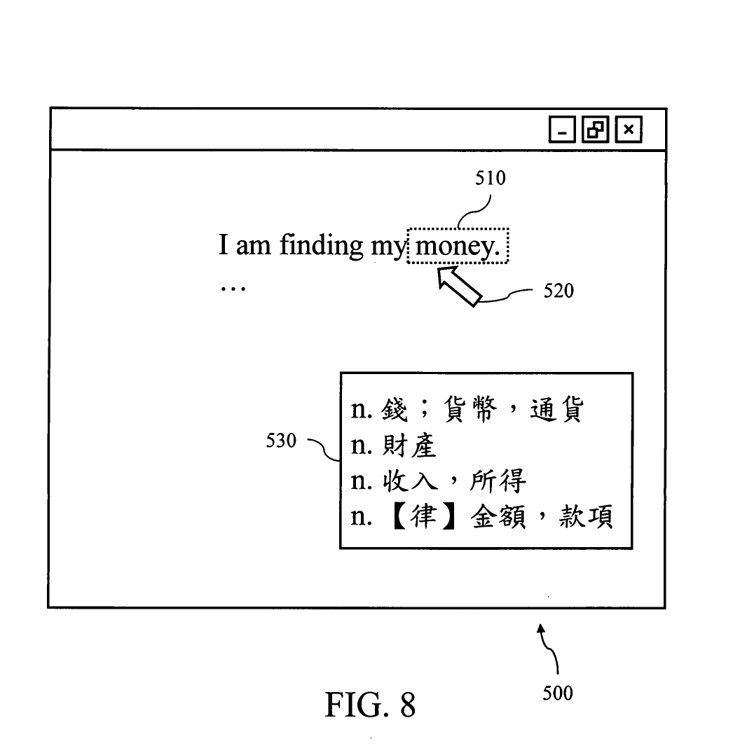

Please refer to FIG. 8. The disclosed system 100 that integrates word explanations in different dictionary databases displays in a word explanation display field 530 of the word search operating interface 500 the explanations 720 [symbol] [symbol] [symbol] [symbol] and [symbol] along with their attribute 730 “n” (step 206).

In summary, the invention differs from the prior art in that it first searches for word explanations in multiple dictionary databases and then compares the contents of explanations with the same attribute. Repeated contents of explanations are combined, while unrepeated contents are preserved. Finally, the combined and preserved explanations are displayed. This solves the problem that the display page of word explanations may be too long for the user to read when all of them are displayed simultaneously. The invention achieves the goal of integrate same or similar explanations for the convenience of the user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display system that integrates word explanations in different dictionary databases, comprising:
a plurality of dictionary databases, each of which stores a plurality of word data, each of the word data has at least one explanation and each of the explanations has an attribute and a dictionary number;
a receiving module for receiving a search word;
a searching module for searching matched word data in the dictionary databases according to the search word;
an extracting module for extracting the explanations associated with the matched word data from the dictionary databases along with the corresponding attributes and the dictionary numbers;
a comparing module for comparing the contents of the explanations with a same attribute and obtaining an updated list by combining repeated contents of the explanations and recording the corresponding dictionary numbers and preserving unrepeated contents of explanations; and
a displaying module for displaying the explanations and the corresponding attributes in the updated list.

2. The display system that integrates word explanations in different dictionary databases as in claim 1, wherein the search word is a word pointed by the mouse cursor.

3. The display system that integrates word explanations in different dictionary databases as in claim 1, wherein the displaying module further displays a hyperlink for each of the matched word data in the dictionary databases according to the dictionary numbers of the explanations.

4. A display method that integrates word explanations in different dictionary databases, comprising the steps of:
establishing a plurality of dictionary databases, each of which stores a plurality of word data; wherein each of the word data has at least one explanation and each of the explanations has an attribute and a dictionary number;
receiving a search word;
searching for matched word data in the dictionary databases according to the search word;
extracting the explanations associated with the matched word data from the dictionary databases along with the corresponding attributes and dictionary numbers;
comparing contents of the explanations with a same attribute and obtaining an updated list by combining repeated contents of the explanations and recording the corresponding dictionary numbers and preserving unrepeated contents thereof; and
displaying the explanations and the corresponding attributes in the updated list.

5. The display method that integrates word explanations in different dictionary databases as in claim 4, wherein the search word is a word pointed by the mouse cursor.

6. The display method that integrates word explanations in different dictionary databases as in claim 4, wherein the step of displaying the explanations and the corresponding attributes in the updated list further includes the step of displaying a hyperlink for each of the matched word data in the dictionary databases according to the dictionary numbers of the explanations.
